(19) United States
(12) Patent Application Publication
(10) Pub. No.: US 2004/0052612 A1
(43) Pub. Date: Mar. 18, 2004

(54) Fastener

(75) Inventor: Hideya Miura, Toyoake-shi (JP)

Correspondence Address: KANESAKA AND TAKEUCHI, Suite 2, 1423 Powhatan Street, Alexandria, VA, 22314, US

(73) Assignee: NIFCO INC.

(21) Appl. No.: 10/461,391

(22) Filed: Jun. 16, 2003

(30) Foreign Application Priority Data
Sep. 12, 2002 (JP) 2002-266505

(51) Int. Cl. F16B 19/00

(52) U.S. Cl. 411/508

(57) ABSTRACT

A fastener includes a head portion and an engagement leg. The engagement leg is formed of elastic pieces projecting from the head portion having projections formed on outer faces of the elastic pieces at the middle in a vertical direction. Each projection has a height relative to the head portion different from that of an adjacent projection. It is preferable that the projections at a diagonal position have the same heights.

### BACKGROUND OF THE INVENTION AND RELATED ART STATEMENT

The present invention relates to a fastener for attaching a component to a body of an automobile or a panel of a main member of an electric equipment, or for attaching a panel to another panel.

A conventional fastener is composed of a head portion; an engagement leg including multiple elastic engagement pieces providing projections on an outer face of elastic pieces projecting from the head portion at the middle in the vertical direction; and an elastic seal portion provided between the engagement leg and the head portion (for example, refer to Japanese Patent Publication (TOKKAI) No. 05-164120).

When the engagement leg of the fastener is pressed into an attaching hole formed in a panel as an attached member from a lower end, an inner portion of the attaching hole presses the multiple elastic pieces through the projections. Accordingly, the multiple elastic pieces deform inwardly, and the engagement leg can be inserted into the attaching hole until the elastic seal portion abuts against a surface of the panel.

When the engagement leg is inserted into the attaching hole until the elastic seal portion abuts against the surface of the panel, the multiple elastic engagement pieces try to return to the former state by the elasticity. An upper end of the projection provided on each elastic piece abuts against a backside of the panel or a backside edge of the attaching hole, so that a rim of the elastic seal portion and the multiple projections support the panel, thereby attaching the fastener to the panel.

In the conventional fastener, the projections have the same height. In other words, a distance, i.e. supportable distance, between the rim of each projection and the rim of the elastic seal portion deformed slightly upward is all the same. Therefore, the conventional fastener can hold a panel having a thickness within only a certain range. Accordingly, when the fastener is attached to a panel having a thickness out of the range, it is necessary to use a different fastener.

The present invention is proposed in order to solve the above-mentioned problems, and an object of the present invention is to provide a fastener capable of being attached to a member having a thickness with one of at least two ranges.

Further objects and advantages of the invention will be apparent from the following description of the invention.

### SUMMARY OF INVENTION

According to the present invention, a fastener includes a head portion and an engagement leg. The engagement leg is formed of elastic pieces projecting from the head portion and a plurality of elastic engagement pieces having projections formed on outer faces of the elastic pieces at the middle in a vertical direction. Further, each projection has a height different from that of an adjacent projection. It is preferable that a projection has a height same as that of a projection located at a diagonal position.

### BRIEF DESCRIPTION OF THE DRAWINGS

FIG. 1 is a front view of a fastener according to the present invention;

FIG. 2 is a plan view of the fastener according to the present invention;

FIG. 3 is a bottom view of the fastener according to the present invention;

FIG. 4 is a left side view of the fastener according to the present invention;

FIG. 5 is a cross sectional view taken along line 5-5 in FIG. 1;

FIG. 6 is a partial cross sectional view taken along line 6-6 in FIG. 3;

FIG. 7 is a view showing a state where the fastener of the present invention is used; and

FIG. 8 is a view showing the state where the fastener of the present invention is used.

### DETAILED DESCRIPTION OF PREFERRED EMBODIMENTS

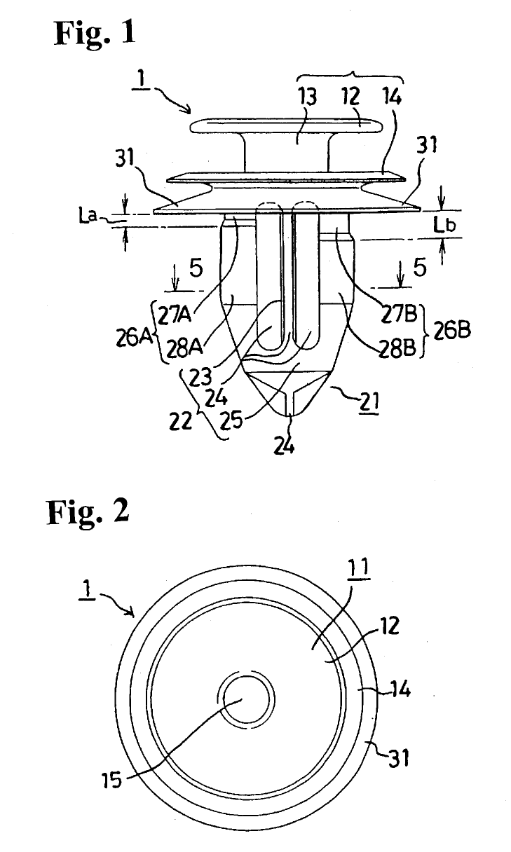

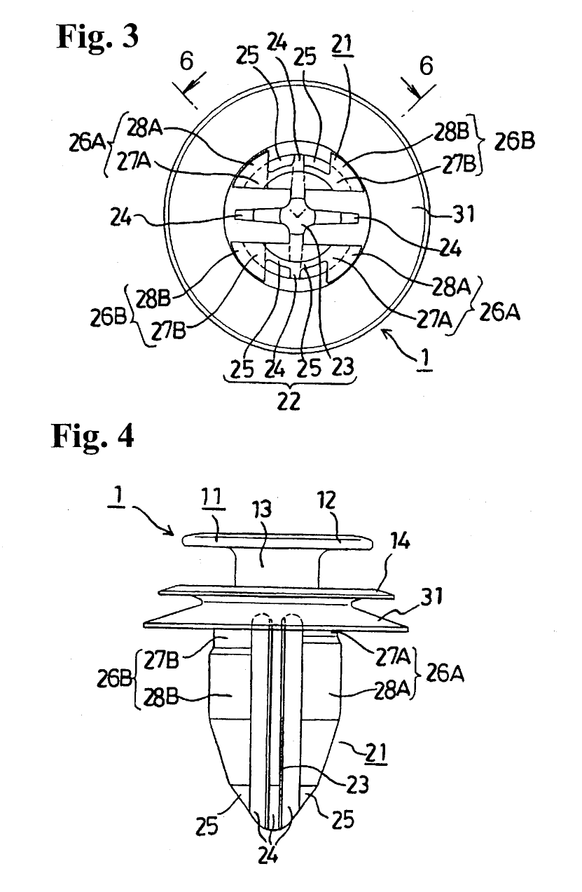

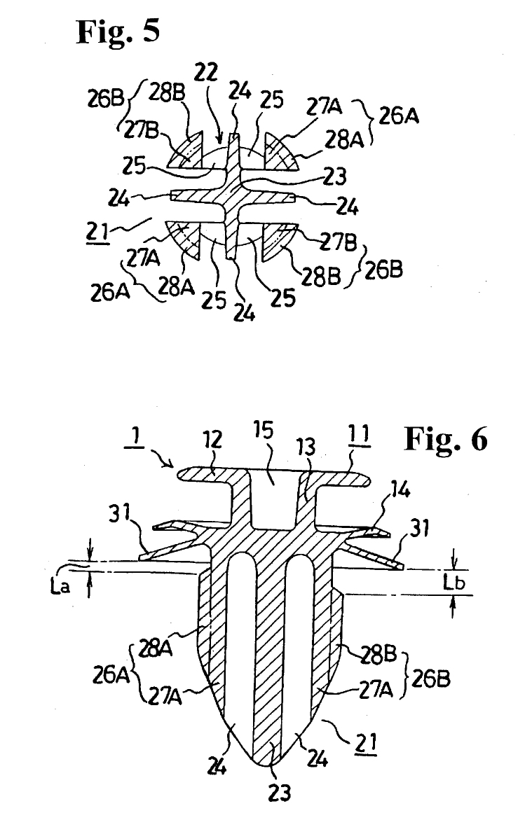

Hereinafter, embodiments of the present invention will be explained with reference to the accompanying drawings. FIG. 1 is a front view of a fastener of the present invention. FIG. 2 is a plan view of the fastener of the present invention. FIG. 3 is a bottom view of the fastener of the present invention. FIG. 4 is a left side view of the fastener of the present invention. FIG. 5 is a cross sectional view taken along line 5-5 in FIG. 1, and FIG. 6 is the cross sectional view taken along line 6-6 in FIG. 3. The rear view is the same as the front view, and the right side face view is the same as the left side face view. In FIGS. 5 and 6, phantom lines indicate elastic pieces and projections of elastic engagement pieces.

As shown in FIG. 1, a fastener 1 is formed of a synthetic resin. The fastener 1 includes a head portion 11; an engagement leg 21 including multiple elastic engagement pieces 26A, 26B having projections 28A, 28B formed at the middle in the vertical direction on outer faces of elastic pieces 27A, 27B projecting from the center of a lower side of the head portion 11; and an elastic seal portion 31 provided between the engagement leg 21 and the head portion 11.

As shown in FIG. 2, the head portion 11 is composed of an upper collar 12 having a circular shape and a predetermined outer diameter; a neck portion 13 having a diameter smaller than the outer diameter of the upper collar 12 and projecting at the center of a lower surface of the upper collar 12; and a lower elastic collar 14 having a diameter larger than the upper collar 12. The lower elastic collar 14 is formed around the neck portion 13 at a lower outer periphery thereof, and has a waving surface lowering after rising toward the upper collar 12 from an inner periphery to an outer periphery as shown in FIG. 6. As shown in FIGS. 2 and 6, a depression 15 extending from the upper collar 12 to the lower elastic collar 14 is provided at the center of the neck portion 13.

As shown in FIGS. 5 and 6, the engagement leg 21 is composed of an axial core portion 22 projecting at the center of the lower side of the head portion 11; and elastic engagement pieces 26A, 26B projecting from the lower side of the head portion 11 and formed along the axial core portion 22 between the projected pieces 24 of the axial core portion 22.

As shown in FIGS. 1 and 3-5, the axial core portion 22 is composed of an axial core 23 projecting at the center of the lower side of the head portion 11; four projected pieces 24 formed on the peripheral face of the axial core 23 along the axial direction and shifted 90 degrees with each other; and two connecting portions 25, each connecting a pair of the elastic engagement pieces 26A, 26B and the lower portion of the projected piece 24 located between the elastic engagement pieces 26A, 26B. The elastic engagement pieces 26A, 26B having a fan-shaped cross section are alternately disposed one by one between the four projected pieces 24 as shown in FIGS. 3 and 5.

As shown in FIGS. 3, 5, and 6, the elastic engagement pieces 26A, 26B are composed of two elastic pieces 27A, 27B located between the projected pieces 24 below the head portion 11; and projections 28A, 28B provided on the outer faces of the elastic pieces 27A, 27B at the middle in the vertical direction. The elastic pieces 27A, 27B are connected at lower portions thereof through the connecting portions 25. As shown in FIGS. 1 and 6, the projections 28A (or the projections 28B) located at the diagonal positions (axial symmetry positions) have the same height. The adjacent projections 28A and 28B have different heights. In other words, an interval (supportable interval) La between a rim of the elastic seal portion 31 deformable slightly upward and a rim of the projections 28A is smaller than an interval (supportable interval) Lb between a rim of the elastic seal portion 31 and a rim of the projections 28B.

A circle connecting the outer faces of the four projected pieces 24 and the elastic pieces 27A, 27B has a diameter smaller than those of the attaching holes 52, 54 of panels 51, 53 (described later). A circle connecting the outer faces of the four projections 28A, 28B has a diameter larger than those of the attaching holes 52, 54 of the panels 51, 53.

Furthermore, an upper end of each projection 28A, 28B has a face declining toward outside (declining face expanding downwardly). Also, a gap (slit, etc.) is provided between the axial core portion 22 and the elastic engagement pieces 26A, 26B for allowing the elastic engagement pieces 26A, 26B to bend inwardly. A lower end part of the engagement leg 21 is formed in a cone shape reducing downwardly. A guide face is provided on a lower end part of the engagement leg 21.

As shown in FIGS. 2 and 6, the elastic seal portion 31 has a circular cone face declining outwardly, and a circular shape with a diameter larger than the lower elastic collar 14.

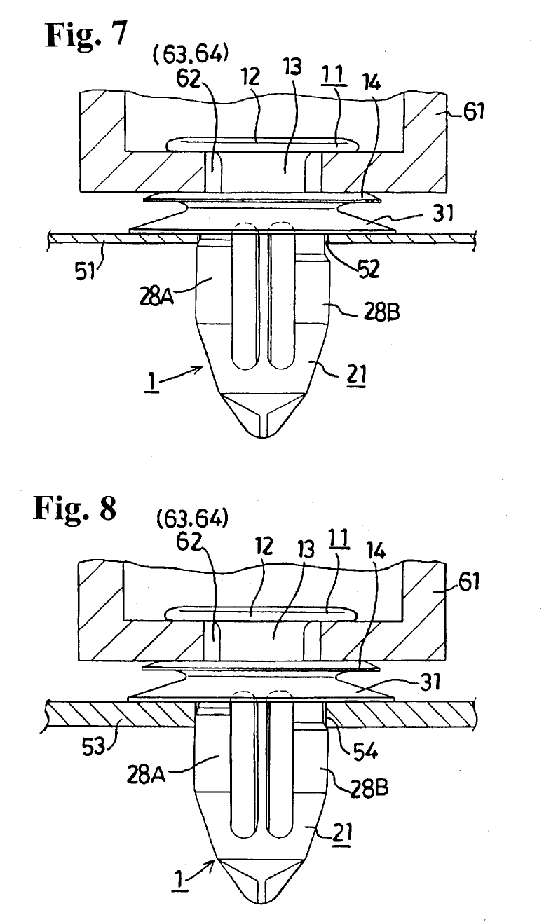

FIGS. 7 and 8 are views showing states where the fastener of the first embodiment of the present invention shown in FIGS. 1-6 is used. In FIGS. 7 or 8, the circular attaching holes 52, 54 for attaching the fastener 1 are provided in the panels 51, 53 as members to be attached. The panel 51 has a thickness that the fastener 1 can be attached by using the projections 28A of the elastic engagement pieces 26A. The panel 53 has a thickness that the fastener 1 can be attached by using the projections 28B of the elastic engagement pieces 26B.

A keyhole 62 to be attached to the fastener 1 is provided in an attaching panel 61 as an attaching member. The keyhole 62 includes a circular through-hole 63 having a diameter larger than the upper collar 12 and smaller than the lower elastic collar 14, and an oval engagement hole 64 having a diameter slightly larger than the neck portion 13 and smaller than the upper collar 12.

A process of attaching the attaching panel 61 to the panel 51 using the fastener 1 will be explained next. First, the end of the engagement leg 21 faces the panel 51, and the engagement leg 21 is pressed into the attaching hole 52 from the end. Accordingly, an inside portion of the attaching hole 52 presses the elastic pieces 27A, 27B through the projections 28A, 28B, so that the elastic engagement pieces 26A, 26B deform inwardly. As a result, the engagement leg 21 is inserted into the attaching hole 52 until the elastic seal portion 31 abuts against a surface of the panel 51.

When the engagement leg 21 is inserted into the attaching hole 52 until the elastic seal portion 31 abuts against the surface of the panel 51, the elastic engagement pieces 26B located at axial symmetric positions expand to restore the former state with the elasticity of the elastic pieces 27B. The elastic engagement pieces 26A located at axial symmetric positions try to enlarge with the elasticity of the elastic pieces 27A. The upper ends of the projections 28A provided on the elastic pieces 27A abut against the backside edge of the attaching hole 52. As shown in FIG. 7, the rim of the elastic seal portion 31 and the two projections 28A sandwich the panel 51. Accordingly, the fastener 1 is attached to the panel 51. In the case where the fastener 1 is attached to the panel 51, the upper ends of the two projections 28B are located away from the backside edge of the attaching hole 52, thereby not supporting the panel 51.

Next, the upper collar 12 is passed through the through-hole 63 of the keyhole 62. Then, the attaching panel 61 is shifted to move the neck portion 13 into the engagement hole 64. The neck portion 13 abuts against the back edge of the engagement hole 64. Then, the attaching panel 61 is fixed to the panel 51 with, for example, an attaching screw, so that the attaching panel 61 is attached to the panel 51. In a case that the attaching panel 61 is attached in a suspended state, the attaching panel 61 is moved below the fastener 1 attached in a horizontal position, and the neck portion 13 abuts against the back edge of the engagement hole 64, so that the attaching panel 61 is attached in the suspended state.

A process of attaching the attaching panel 61 to the panel 53 using the fastener 1 will be explained next. First, the end of the engagement leg 21 faces the panel 53, and the engagement leg 21 is pressed into the attaching hole 54 from the end. The inside part of the attaching hole 54 pushes the elastic pieces 27A, 27B through the projections 28A, 28B, so that the elastic engagement piece 26A, 26B deform inwardly. As a result, the engagement leg 21 is inserted into the attaching hole 54 until the elastic seal portion 31 abuts against the surface of the panel 53.

When the engagement leg 21 is inserted into the attaching hole 54 until the elastic seal portion 31 abuts against the surface of the panel 53, the elastic engagement pieces 26B located at the axial symmetric positions try to expand with the elasticity of the elastic pieces 27B. The upper ends of the projections 28B provided on the elastic pieces 27B abut against the backside edge of the attaching hole 54. As a result, as shown in FIG. 8, the rim of the elastic seal portion 31 and the projections 28B sandwich the panel 53. Accordingly, the fastener 1 is attached to the panel 53. When the fastener 1 is attached to the panel 53, the inside part of the attaching hole 54 keeps pushing the two projections 28A, and the two elastic engagement pieces 26A remain deformed inwardly, so that the two projections 28A do not contribute to support the panel 53. After that, the attaching panel 61 is fixed to the panel 53 with the method mentioned above.

According to the present invention, the adjacent projections 27A, 27B have different heights. Therefore, the attaching panel 61 can be attached to the panels 51, 53 having thicknesses within the two permissible ranges by using the fastener 1. The projections 28A (or 28B) located at the diagonal positions have the same height, so that the fastener 1 can be firmly attached to the panel 51 (or 53).

In the present embodiment, the fastener is provided with four projected pieces 24, two respective elastic engagement pieces 26A, 26B, and two respective projections 28A, 28B. It is possible that an even number (more than two) of the projected pieces is provided (or not provided at all), and an even number (more than two) of the elastic engagement pieces is provided. In this case, the adjacent projections may have different heights, or the projections at the diagonal positions may have the same height. Alternatively, it is possible that more than two of the projected pieces are provided (or not provided at all), and more than two of the elastic engagement pieces are provided. In this case, the adjacent projections may have different heights. With the above-mentioned configurations, the fastener can be attached to the attached members having thicknesses within at least two permissible ranges.

In the embodiment, the projections 28A, 28B at the diagonal positions have the same height. It is also possible that the projections at the diagonal positions have different heights. Furthermore, in the embodiment, the projections 28A (or 28B) and the elastic seal portion 31 support the panels 51 (or 53). Alternatively, the elastic seal portion 31 may be omitted. In this case, the head portion 11 (lower elastic collar 14, or simply lower collar) and the projections 28A (or 28B) support the panels 51 (or 53).

According to the present invention, the adjacent projections have the different heights. Therefore, the fastener can be attached to the attached members having thicknesses within at least two permissible ranges. The projections at the diagonal positions have the same height, so that the fastener can be firmly attached to the attached members.

While the invention has been explained with reference to the specific embodiments of the invention, the explanation is illustrative and the invention is limited only by the appended claims.

What is claimed is:

1. A fastener for fastening two members, comprising:
a head portion, and
an engagement leg extending from the head portion and including a plurality of elastic engagement pieces having projections extending laterally outwardly therefrom at middle portions thereof, a distance between one of the projections and the head portion being different from that between the other of the projections and the head portion to receive a panel with different thicknesses.

2. A fastener according to claim 1, wherein said elastic pieces are arranged circularly, at least two of the elastic pieces being arranged symmetrically relative to a center axis of the engagement leg and having the projections with the same distances.

3. A fastener according to claim 2, wherein said elastic engagement pieces are disposed on the engagement leg with a space in between so that the engagement pieces elastically deform inwardly.

4. A fastener according to claim 1, wherein said projections include first projection portions and second projection portions disposed alternately with the first projection portions, said first projection portions being situated away from the head portion by a first distance, said second projection portions being situated away from the head portion by a second distance different from the first distance.

5. A fastener according to claim 4, wherein said first and second projection portions with different distances are located, respectively, at diagonal locations relative to a longitudinal axis of the engagement leg.

6. A fastener according to claim 1, wherein said head portion has a groove around a peripheral thereof for inserting one of the two member to be fastened.

7. A fastener according to claim 1, further comprising an elastic seal portion provided between the engagement leg and the head portion.
